(19) United States
(12) Patent Application Publication
(10) Pub. No.: US 2019/0361939 A1
(43) Pub. Date: Nov. 28, 2019

(54) SEARCH PROCESSING APPARATUS AND NON-TRANSITORY COMPUTER READABLE MEDIUM STORING PROGRAM

(71) Applicant: FUJI XEROX CO., LTD., Tokyo (JP)

(72) Inventors: Yasushi ITO, Kanagawa (JP); Yasuhiro ITO, Kanagawa (JP); Shinya TAGUCHI, Kanagawa (JP); Kazuki YASUMATSU, Kanagawa (JP); Keita ASAI, Kanagawa (JP)

(73) Assignee: FUJI XEROX CO., LTD., Tokyo (JP)

(21) Appl. No.: 16/354,215

(22) Filed: Mar. 15, 2019

(30) Foreign Application Priority Data
May 24, 2018 (JP) 2018-099249

(51) Int. Cl. G06F 16/9035; G06F 16/903; G06F 16/9038

(52) U.S. Cl. CPC G06F 16/9035; G06F 16/9038; G06F 16/90344

(57) ABSTRACT

A search processing apparatus includes: a time-point information obtaining section that obtains time-point information corresponding to plural time-points associated with target data; a feature information obtaining section that obtains feature information corresponding to one or more feature terms from the target data; and a search condition generating section that generates search conditions corresponding to the plural time-points by combining the time-point information and the feature information.

### CROSS-REFERENCE TO RELATED APPLICATIONS

This application is based on and claims priority under 35 USC 119 from Japanese Patent Application No. 2018-099249 filed May 24, 2018.

### BACKGROUND

### (i) Technical Field

The present invention relates to a search processing apparatus and a non-transitory computer readable medium storing a program.

### (ii) Related Art

JP2008-165303A discloses an apparatus which resisters a score representing a tag in which a keyword representing features of contents is written, a related word of the keyword, and the degree of association of the related word for the keyword, in association with the contents.

JP2003-132049A discloses an apparatus which automatically recognizes a search keyword from a multimedia document, and searches for and presents contents highly relevant to the search keyword from a content database.

JP2002-324071A discloses a technology capable of searching for contents in accordance with a time axis by detecting a time zone of contents in which a scene corresponding to a specific image associated with a keyword appears, detecting a time zone of the contents in which a sound corresponding to a specific voice associated with the keyword appears, generating an index file in association with information of the detected time zones and the keyword, and using the index file.

### SUMMARY

In the related art, there is known a technology of searching for contents highly relevant to target data, for example, by using a keyword or the like (see JP2008-165303A, JP2003-132049A, and JP2002-324071A). On the other hand, there is also a need to search for a transition in information associated with the target data (including temporal change of information).

Aspects of non-limiting embodiments of the present disclosure relate to a search processing apparatus and a non-transitory computer readable medium storing a program, which provide a search condition for searching for a transition of information associated with target data.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a search processing apparatus including: a time-point information obtaining section that obtains time-point information corresponding to a plurality of time-points associated with target data; a feature information obtaining section that obtains feature information corresponding to one or more feature terms from the target data; and a search condition generating section that generates search conditions corresponding to the plurality of time-points by combining the time-point information and the feature information.

### BRIEF DESCRIPTION OF THE DRAWINGS

Exemplary embodiment(s) of the present invention will be described in detail based on the following figures, wherein:

FIG. 1 is a diagram illustrating a specific example of a search processing apparatus;

FIG. 2 is a diagram illustrating Specific Example 1 of a process executed by the search processing apparatus;

FIG. 3 is a diagram illustrating Specific Example 1 of contents of target data;

FIG. 4 is a diagram illustrating Specific Example 1 of a search condition and a search result;

FIG. 5 is a diagram illustrating Specific Example 2 of the process executed by the search processing apparatus;

FIG. 6 a diagram illustrating Specific Example 2 of the contents of the target data; and

FIG. 7 is a diagram illustrating Specific Example 2 of the search condition and the search result.

### DETAILED DESCRIPTION

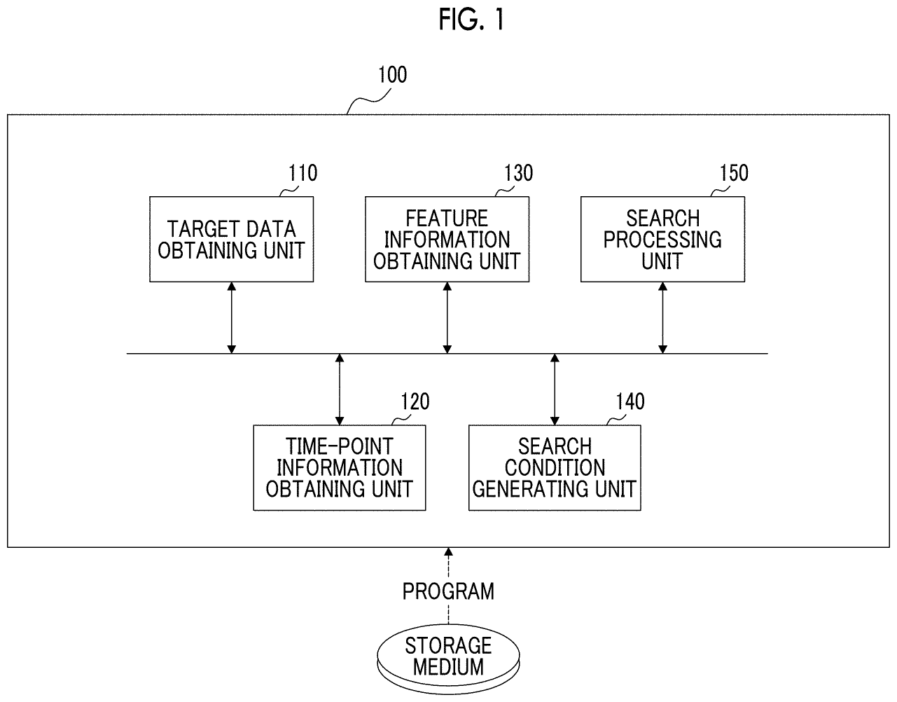

FIG. 1 is a diagram illustrating a specific example of the exemplary embodiment of the invention. FIG. 1 illustrates a specific example of a search processing apparatus 100. In the specific example in FIG. 1, the search processing apparatus 100 includes a target data obtaining unit 110, a time-point information obtaining unit 120, a feature information obtaining unit 130, a search condition generating unit 140, and a search processing unit 150.

The target data obtaining unit 110 obtains target data used for a search process. The target data obtaining unit 110 may obtain the target data from an external device such as a computer via a communication line (communication network) or the like, may obtain the target data via a device which read data from a storage medium such as an optical disk, a semiconductor memory, a card memory, or the like, or may obtain the target data from an image reading device such as a scanner or the like. Data already stored in the search processing apparatus 100 may be used as the target data.

The time-point information obtaining unit 120 obtains time-point information corresponding to a plurality of time-points associated with the target data. The time-point includes a meaning of one point, a certain time, or the like on a time flow, for example. In addition, specific examples of the time-point include one point (moment), a time (period), and the like on a time axis specified by at least one piece of information related to temporal designation such as “year”, “month”, “day”, “time”, “season (spring, summer, fall, and winter)”, “first half”, “second half”, or the like.

For example, the time-point information obtaining unit 120 may extract at least some pieces of the time-point information from contents of the target data or may extract at least some pieces of the time-point information from contents searched by using feature information described below. The content of the target data is data related to content of the target data. For example, specific examples of the contents of the target data include document data, image data, audio data, video data, and the like.

The feature information obtaining unit 130 obtains the feature information corresponding to one or more feature terms from the target data. The feature term is a distinctive term associated with the target data. The feature information obtaining unit 130 may obtain the feature information, for example, by extracting one or more feature terms among a plurality of terms included in the contents of the target data. For example, a term which is a keyword included in the contents of the target data may be extracted as a feature term.

The search condition generating unit 140 generates search conditions corresponding to the plurality of time-points by combining the time-point information and the feature information. For example, the search condition generating unit 140 may generate the search condition corresponding to the time-point for each of the time-points.

The search processing unit 150 executes the search process by using the search condition generated by the search condition generating unit 140. For example, the search processing unit 150 may execute the search process based on the search condition or, for example, the search condition may be transmitted to an external device other than the search processing apparatus 100 and the external device may execute the search process. For the search process, for example, a known search engine (search engine) may be used. In a case of the search process using the known search engine, for example, a text string or a combination of text strings to be input to the search engine is generated as the search condition.

The search processing apparatus 100 illustrated in FIG. 1 may be, for example, a user device directly used by a user. A specific example of the user device includes an information processing device such as a computer, a smartphone, a tablet, or the like. In a case where the search processing apparatus 100 is the user device, for example, the search processing apparatus 100 generates the search condition according to an instruction received from the user via an operation device or the like. Further, for example, the search processing apparatus 100 may execute the search process based on the search condition and may provide a search result to the user.

In addition, the search processing apparatus 100 illustrated in FIG. 1 also may be, for example, a service device which provides a search service to the user device used by the user. The service device may be realized by using the information processing device such as a computer. In a case where the search processing apparatus 100 is the service device, for example, the search processing apparatus 100 generates the search condition according to information (instruction or the like from the user) transmitted from the user device and transmits information of the generated search condition to the user device. Further, for example, the search processing apparatus 100 may execute the search process based on the search condition and may transmit information of the search result to the user device.

In a case where the search processing apparatus 100 in FIG. 1 is realized by using, for example, a computer (which may be an information processing device such as a smartphone, a tablet, or the like), the computer includes hardware resources of an arithmetic device such as a CPU, a storage device such as a memory or a hard disk, a communication device using a communication line such as the internet, a device for reading or writing data from or to a storage medium such as an optical disk, a semiconductor memory, or a card memory, a display device such as a display, an operation device for receiving an operation from a user, and the like.

For example, a program (software) corresponding to functions of at least some units among a plurality of units denoted by reference numerals and included in the search processing apparatus 100 illustrated in FIG. 1 is read into the computer and at least some functions included the search processing apparatus 100 is realized by a collaboration between the hardware resources of the computer and the read software. For example, the program may be provided to a computer (search processing apparatus 100) via a communication line such as the internet, or may be stored in a storage medium such as an optical disk, a semiconductor memory, or a card memory and provided to a computer (search processing apparatus 100).

An overall configuration of the search processing apparatus 100 illustrated in FIG. 1 is as described above. Next, processes and the like realized by the search processing apparatus 100 in FIG. 1 will be described in detail. For the configuration (part) illustrated in FIG. 1, the reference numerals in FIG. 1 are used in the following description.

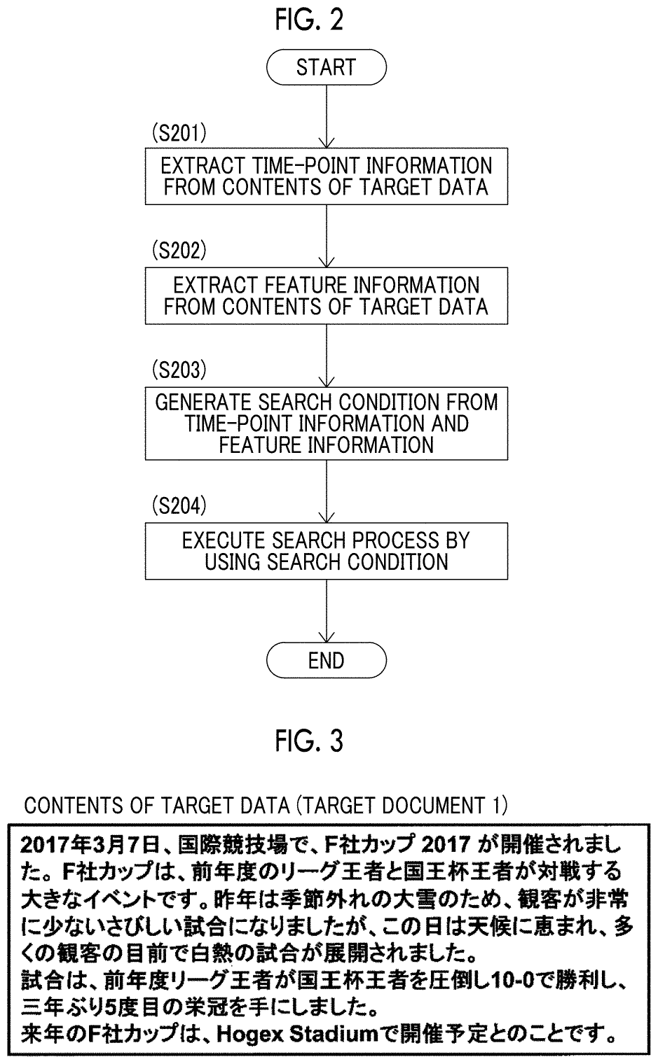

FIG. 2 is a diagram (flowchart) illustrating Specific Example 1 of the processes executed by the search processing apparatus 100. FIG. 2 illustrates a specific example of the process of searching for a transition of the information associated with the target data obtained by the target data obtaining unit 110. In addition, FIG. 3 is a diagram illustrating Specific Example 1 of the contents of the target data. FIG. 3 illustrates document data (target document 1) which is the specific example of the contents of the target data.

In Specific Example 1 illustrated in FIG. 2, the time-point information obtaining unit 120 extracts the time-point information from the contents of the target data (S201). For example, the time-point information obtaining unit 120 extracts a specific expression corresponding to one or more time-points from the contents of the target data. For example, the time-point information obtaining unit 120 extracts the specific expression corresponding to a predetermined regular expression from the contents of the target data. For example, the specific expression corresponding to the regular expression in which a text such as “ [symbol] (year)” is followed immediately after numbers is extracted.

In Specific Example 1 illustrated in FIG. 3, “2017 [symbol] ” is extracted as a specific expression from the expressions included in the target document 1. In addition, in Specific Example 1 illustrated in FIG. 3, “2017 [symbol] 3 [symbol] 7 [symbol] ” may be extracted as a specific expression corresponding to the regular expression obtained by combining the numbers and “ [symbol] (year)”, “ [symbol] (month)”, and“ [symbol] (day)”. Further, the specific expression corresponding to the regular expression obtained by disassembling the contents of the document data into morphemes (words or the like) by morphological analysis or the like may be extracted or a similar expression of the regular expression may be extracted as a specific expression.

In addition, for example, in a case where a precondition for searching is designated, the time-point information satisfying the precondition may be extracted. For example, in a case where “before 2018” is set as a precondition for searching, the time-point information corresponding to the time-point before 2018 is extracted. According to Specific Example 1 illustrated in FIG. 3, “2017 [symbol] ” is extracted as a time-point information corresponding to the time-point before 2018. As a precondition for searching, a period (for example, after 2000 and before 2018) may be set.

In addition, for example, the time-point information obtaining unit 120 may obtain the time-point information from information set by the user. For example, “2018” included in “before 2018” set as a precondition for searching may be obtained as time-point information. In addition, for example, the time-point information obtaining unit 120 may obtain the time-point information from attribute information (meta data) of the target data.

In Specific Example 1 illustrated in FIG. 2, the feature information obtaining unit 130 extracts the feature information from the contents of the target data (S202). For example, the feature information obtaining unit 130 extracts one or more feature terms among the plurality of terms included in the contents of the target data. For example, the feature information obtaining unit 130 extracts one or more terms of which an index, obtained for each of the terms by analyzing all of the contents, satisfies the predetermined condition among the plurality of terms included in the contents of the target data as feature terms. Accordingly, for example, the term which is a keyword included in the contents of the target data is extracted as a feature term.

According to Specific Example 1 illustrated in FIG. 3, for example, all of the contents in the target document 1 are analyzed by using an analysis process such as a natural language analysis and a score (index value) which is an index such as importance, degree of association, reliability, or the like of the terms in the target document 1 is derived. Then, for example, the term of which the score, obtained for each of the terms, is equal to or larger than a predetermined reference value is extracted as a feature term. Accordingly, for example, “ [symbol] (international stadium)”, “ [symbol] (F company cup)”, and “ [symbol] (league champion)” are extracted from the target document 1 illustrated in FIG. 3 as feature terms.

FIG. 3 illustrates the specific example in which the contents of the target data is the document data, but the contents of the target data may be, for example, image data, audio data, video data, or the like. In a case where the target data is the image data, for example, a text (document) is extracted from the image data by using an analysis process such as optical text recognition. In addition, in a case where the target data is the audio data, for example, a text (document) is extracted from the audio data by using an audio recognition process or the like. Further, in a case where the target data may be the video data, for example, a text is extracted from the video data by a process using both of optical text recognition and audio recognition. Then, the process of Specific Example 1 illustrated in FIG. 2 may be executed on document data configured to include the extracted texts as a process target.

Furthermore, information (age, sex, language, name, and the like in a case where a subject is a person or name, type, and the like in a case where the subject is a thing) obtained from image information included in the image data, a place and a date at which the image data is generated, or the like may be extracted as feature information. In addition, information on a speaker obtained from the audio data (age, sex, language, name, and the like of the speaker), a place and a date at which the audio data is generated, or the like may be extracted as feature information. Further, for example, the feature information may be extracted from the attribute information (meta data) of the target data.

Thus, in Specific Example 1 illustrated in FIG. 2, in a case where the specific expression which is the time-point information and the feature term which is the feature information are extracted, the search condition generating unit 140 generates the search condition corresponding to the plurality of time-points from the time-point information and the feature information (S203). The search process using the generated search condition is executed (S204).

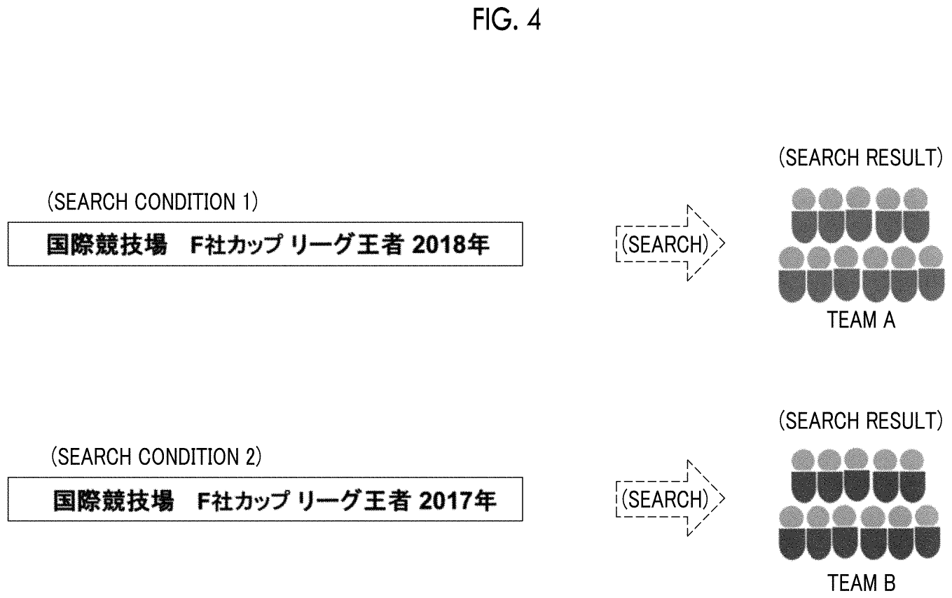

FIG. 4 is a diagram illustrating Specific Example 1 of the search condition and the search result. FIG. 4 illustrates the specific example of the search condition and the search result related to the target data illustrated in FIG. 3.

The search condition generating unit 140 generates the search conditions corresponding to the plurality of time-points by combining the time-point information and the feature information. For example, the search condition generating unit 140 generates the search condition corresponding to the time-point for each of the time-points.

For example, in a case where “2018 [symbol] ” and “2017 [symbol] ” are extracted as the time-point information related to the target data illustrated in FIG. 3 and “ [symbol] (international stadium)”, “ [symbol] (F company cup)”, and “ [symbol] (league champion)” are extracted as the feature information related to the target data illustrated in FIG. 3, a search condition 1 and a search condition 2 illustrated in FIG. 4 are generated.

For example, the search condition generating unit 140 generates the search condition 1 in FIG. 4 as a search condition corresponding to “2018 [symbol] ” by combining “2018 [symbol] ” which is one piece of the time-point information and “ [symbol] (international stadium)”, “ [symbol] (F company cup)”, and “ [symbol] (league champion)” which are pieces of the feature information. In addition, the search condition generating unit 140 generates the search condition 2 in FIG. 4 as a search condition corresponding to “2017 [symbol] ” by combining “2017 [symbol] ” which is one piece of the time-point information and “ [symbol] (international stadium)”, “ [symbol] (F company cup)”, and “ [symbol] (league champion)” which are pieces of the feature information.

The search process using the generated search condition is executed. FIG. 4 illustrates the specific example of the search result obtained by the search process using the search condition 1 and the search condition 2. In the specific example illustrated in FIG. 4, an image of a team A is obtained as a search result under the search condition 1 and an image of a team B is obtained as a search result under the search condition 2.

For example, under the search condition 1 illustrated in FIG. 4, the image data of the team A which is “ [symbol] (league champion)” participated in “ [symbol] (F company cup)” in “2018 [symbol] ” is searched and under the search condition 2 illustrated in FIG. 4, the image data of the team B which is “ [symbol] (league champion)” participated in “ [symbol] (F company cup)” in “2017 [symbol] ” is searched. That is, a transition (team B in “2017 [symbol] ” to team A in “2018 [symbol] ”) of “ [symbol] (league champion)” participated in “ [symbol] (F company cup)” is searched as a transition of information associated with the target document 1 in FIG. 3 which is the specific example of the target data. The search result may be displayed on, for example, a display device of the user device used by the user or a display device included in the search processing apparatus 100.

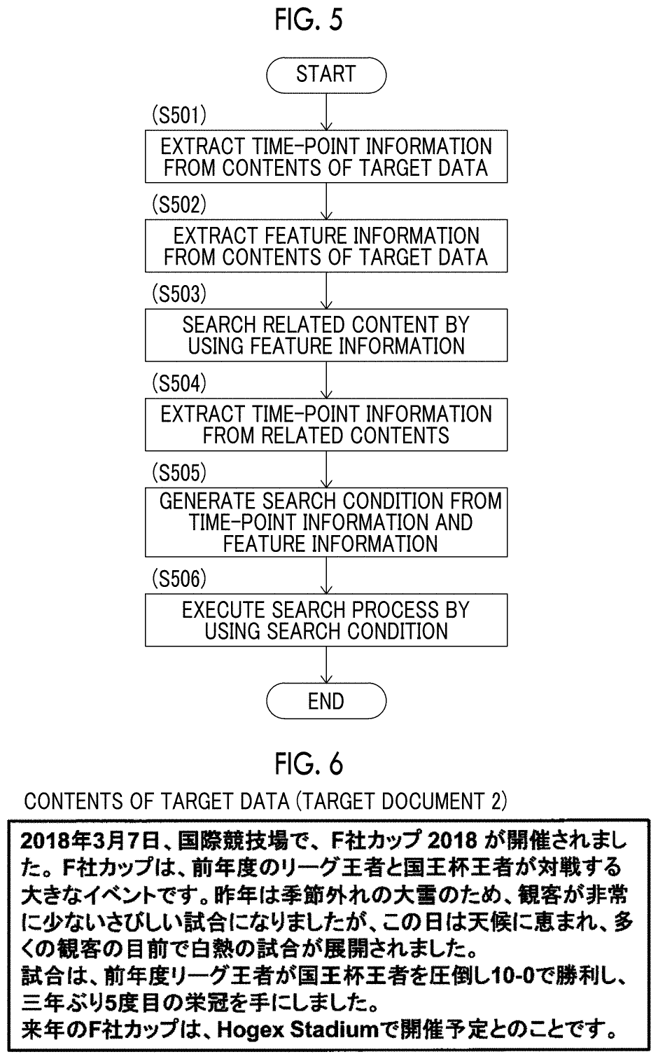

FIG. 5 is a diagram (flowchart) illustrating Specific Example 2 of the processes executed by the search processing apparatus 100. FIG. 5 illustrates a specific example of the process of searching a transition of the information associated with the target data obtained by the target data obtaining unit 110. In addition, FIG. 6 is a diagram illustrating Specific Example 2 of the contents of the target data. FIG. 6 illustrates document data (target document 2) which is the specific example of the contents of the target data.

In Specific Example 2 illustrated in FIG. 5, the time-point information obtaining unit 120 extracts the time-point information from the contents of the target data (S501). For example, the time-point information obtaining unit 120 extracts the specific expression corresponding to one or more time-points from the contents of the target data. For example, the specific expression corresponding to the predetermined regular expression is extracted from the contents of the target data by the same process as the process in Specific Example 1 (S201 in FIG. 2). In Specific Example 2 illustrated in FIG. 6, “2010 [symbol] ” is extracted as a specific expression from the expressions included in the target document 2.

In addition, in Specific Example 2 illustrated in FIG. 5, the feature information obtaining unit 130 extracts the feature information from the contents of the target data (S502). For example, the feature information obtaining unit 130 extracts one or more feature terms among the plurality of terms included in the contents of the target data. For example, by the same process as the process in Specific Example 1 (S202 in FIG. 2), one or more terms of which an index, obtained for each of the terms by analyzing all of the contents, satisfies the predetermined condition are extracted among the plurality of terms included in the contents of the target data as feature terms. Accordingly Specific Example 2 illustrated in FIG. 6, for example, “ [symbol] (international stadium)”, “ [symbol] (F company cup)”, and “ [symbol] (league champion)” are extracted from the target document 2 as feature terms.

FIG. 6 illustrates the specific example in which the contents of the target data is the document data, but the contents of the target data may be, for example, image data, audio data, video data, or the like. Further, for example, at least one piece of the time-point information or the feature information may be extracted from the attribute information (meta data) of the target data.

In Specific Example 2 illustrated in FIG. 5, the search processing unit 150 searches for the content (related content) associated with the target data by using the feature information extracted from the contents of the target data (S503). For example, the search process is executed under the search condition of combining three keywords (arranging three keywords) of “ [symbol] (international stadium)”, “ [symbol] (F company cup)”, and “ [symbol] (league champion)” extracted as feature information and the related contents associated with the target data is obtained as a result of the search process. Accordingly, for example, the document data, the image data, the audio data, the video data, or the like including the contents related to a team C of “ [symbol] (league champion)” in “2016 [symbol] ” and the team B of “ [symbol] (league champion)” in “2017 [symbol] ” is obtained as a related content.

Further, in Specific Example 2 illustrated in FIG. 5, the time-point information obtaining unit 120 extracts the time-point information from the related contents of the target data (S504). For example, the time-point information obtaining unit 120 extracts a specific expression corresponding to one or more time-points from the related contents. For example, the specific expression corresponding to the predetermined regular expression is extracted from the related contents of the target data by the same process as the process in S501 (S201 in FIG. 2). For example, in a case where the document data or the like including the contents related to the team C of “ [symbol] (league champion)” in “2016 [symbol] ” and the team B of “ [symbol] (league champion)” in “2017 [symbol] ” is searched as the related content, “2016 [symbol] ” and “2017 [symbol] ” are extracted as specific expressions.

Thus, in Specific Example 2 illustrated in FIG. 5, in a case where the specific expression which is the time-point information and the feature term which is the feature information are extracted, the search condition generating unit 140 generates the search condition corresponding to the plurality of time-points from the time-point information and the feature information (S505). The search process using the generated search condition is executed (S506).

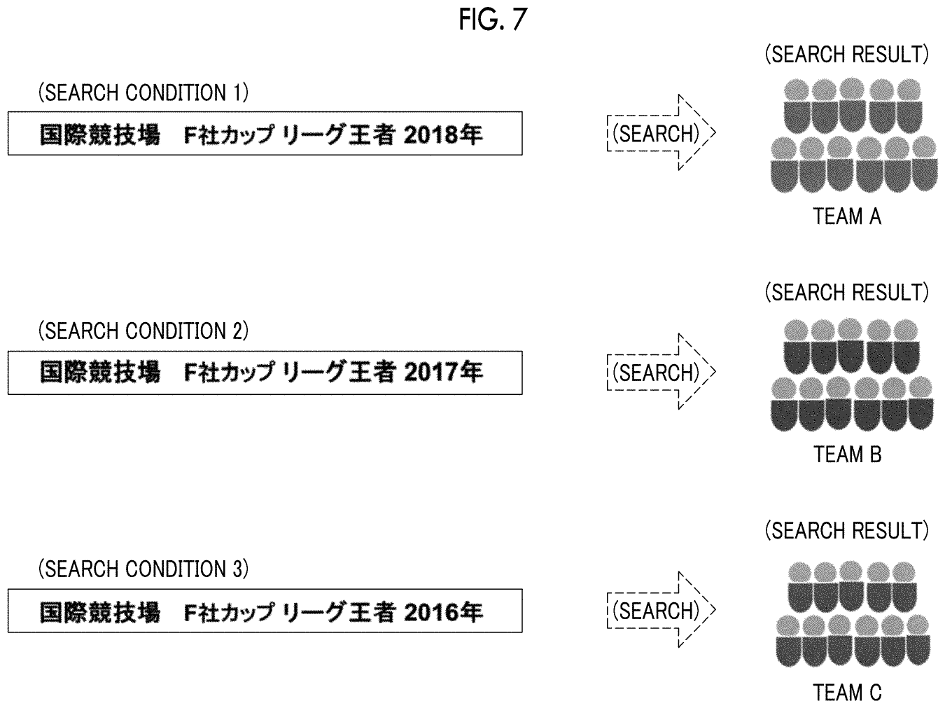

FIG. 7 is a diagram illustrating Specific Example 2 of the search condition and the search result. FIG. 7 illustrates the specific example of the search condition and the search result related to the target data illustrated in FIG. 6.

The search condition generating unit 140 generates the search conditions corresponding to the plurality of time-points by combining the time-point information and the feature information. For example, the search condition generating unit 140 generates the search condition corresponding to the time-point for each of the time-points.

For example, in a case where “2018 [symbol] ” is extracted from the contents of the target data and “2017 [symbol] ” and “2016 [symbol] ” are extracted from the related contents as the time-point information related to the target data illustrated in FIG. 6, and “ [symbol] (international stadium)”, “ [symbol] (F company cup)”, and “ [symbol] (league champion)” are extracted as the feature information related to the target data illustrated in FIG. 6, the search condition 1, the search condition 2, and a search condition 3 illustrated in FIG. 7 are generated.

For example, the search condition generating unit 140 generates the search condition 1 in FIG. 7 as a search condition corresponding to “2018 [symbol] ” by combining “2018 [symbol] ” which is one piece of the time-point information and “ [symbol] (international stadium)”, “ [symbol] (F company cup)”, and “ [symbol] (league champion)” which are pieces of the feature information. In addition, the search condition generating unit 140 generates the search condition 2 in FIG. 7 as a search condition corresponding to “2017 [symbol] ” by combining “2017 [symbol] ” which is one piece of the time-point information and “ [symbol] (international stadium)”, “ [symbol] (F company cup)”, and “ [symbol] (league champion)” which are pieces of the feature information. Further, the search condition generating unit 140 generates the search condition 3 in FIG. 7 as a search condition corresponding to “2016 [symbol] ” by combining “2016 [symbol] ” which is one piece of the time-point information and “ [symbol] (international stadium)”, “ [symbol] (F company cup)”, and “ [symbol] (league champion)” which are pieces of the feature information.

The search process using the generated search condition is executed. FIG. 7 illustrates the specific example of the search result obtained by the search process using the search condition 1, the search condition 2, and the search condition 3. In the specific example illustrated in FIG. 7, the image of the team A is obtained as a search result under the search condition 1, the image of the team B is obtained as a search result under the search condition 2, and an image of the team C is obtained as a search result under the search condition 3.

For example, under the search condition 1 illustrated in FIG. 7, the image data of the team A which is “ [symbol] (league champion)” participated in “ [symbol] (F company cup)” in “2018 [symbol] ” is searched, under the search condition 2 illustrated in FIG. 7, the image data of the team B which is “ [symbol] (league champion)” participated in “ [symbol] (F company cup)” in “2017 [symbol] ” is searched, and under the search condition 3 illustrated in FIG. 7, the image data of the team C which is “ [symbol] (league champion)” participated in “ [symbol] (F company cup)” in “2016 [symbol] ” is searched. That is, a transition (team C in “2016 [symbol] ” to team B in “2017 [symbol] ” to team A in “2018 [symbol] ”) of “ [symbol] (league champion)” participated in “ [symbol] (F company cup)” is searched as a transition of information associated with the target document 2 in FIG. 6 which is the specific example of the target data. The search result may be displayed on, for example, a display device of the user device used by the user or a display device included in the search processing apparatus 100.

According to Specific Example 2 described with reference to FIGS. 5 to 7, since the time-point information is also extracted from the related contents in addition to the contents of the target data, the more time-point information corresponding to the time-point is obtained as compared with a case where the time-point information is extracted from only the contents of the target data.

As described above, the exemplary embodiment of the invention is described, but the described exemplary embodiment is merely an example in all respects and is not intended to limit the scope of the invention. The exemplary embodiment of the invention includes various modifications without departing from the scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A search processing apparatus comprising:
a time-point information obtaining section that obtains time-point information corresponding to a plurality of time-points associated with target data;
a feature information obtaining section that obtains feature information corresponding to one or more feature terms from the target data; and
a search condition generating section that generates search conditions corresponding to the plurality of time-points by combining the time-point information and the feature information.

2. The search processing apparatus according to claim 1,
wherein the time-point information obtaining section extracts at least a piece of the time-point information from contents of the target data.

3. The search processing apparatus according to claim 1,
wherein the time-point information obtaining section extracts at least a piece of the time-point information from contents searched by using the feature information.

4. The search processing apparatus according to claim 2,
wherein the time-point information obtaining section extracts at least a piece of the time-point information from contents searched by using the feature information.

5. The search processing apparatus according to claim 1,
wherein the time-point information obtaining section extracts the time-point information corresponding to one or more time-points from the contents of the target data and extracts the time-point information corresponding to the one or more time-points from contents searched by using the feature information.

6. The search processing apparatus according to claim 2,
wherein the time-point information obtaining section extracts the time-point information corresponding to one or more time-points from the contents of the target data and extracts the time-point information corresponding to the one or more time-points from contents searched by using the feature information.

7. The search processing apparatus according to claim 3,
wherein the time-point information obtaining section extracts the time-point information corresponding to one or more time-points from the contents of the target data and extracts the time-point information corresponding to the one or more time-points from contents searched by using the feature information.

8. The search processing apparatus according to claim 4,
wherein the time-point information obtaining section extracts the time-point information corresponding to one or more time-points from the contents of the target data and extracts the time-point information corresponding to the one or more time-points from contents searched by using the feature information.

9. The search processing apparatus according to claim 2,
wherein the time-point information obtaining section extracts a specific expression corresponding to one or more time-points from the contents to obtain at least a piece of the time-point information from the extracted specific expression.

10. The search processing apparatus according to claim 3,
wherein the time-point information obtaining section extracts a specific expression corresponding to one or more time-points from the contents to obtain at least a piece of the time-point information from the extracted specific expression.

11. The search processing apparatus according to claim 4,
wherein the time-point information obtaining section extracts a specific expression corresponding to one or more time-points from the contents to obtain at least a piece of the time-point information from the extracted specific expression.

12. The search processing apparatus according to claim 5,
wherein the time-point information obtaining section extracts a specific expression corresponding to one or more time-points from the contents to obtain at least a piece of the time-point information from the extracted specific expression.

13. The search processing apparatus according to claim 6,
wherein the time-point information obtaining section extracts a specific expression corresponding to one or more time-points from the contents to obtain at least a piece of the time-point information from the extracted specific expression.

14. The search processing apparatus according to claim 7,
wherein the time-point information obtaining section extracts a specific expression corresponding to one or more time-points from the contents to obtain at least a piece of the time-point information from the extracted specific expression.

15. The search processing apparatus according to claim 8,
wherein the time-point information obtaining section extracts a specific expression corresponding to one or more time-points from the contents to obtain at least a piece of the time-point information from the extracted specific expression.

16. The search processing apparatus according to claim 9,
wherein the time-point information obtaining section extracts the specific expression corresponding to a predetermined regular expression from the contents.

17. The search processing apparatus according to claim 10,
wherein the time-point information obtaining section extracts the specific expression corresponding to a predetermined regular expression from the contents.

18. The search processing apparatus according to claim 1,
wherein the feature information obtaining section extracts the one or more feature terms among a plurality of terms included in contents of the target data to obtain the feature information.

19. The search processing apparatus according to claim 18,
wherein the feature information obtaining section extracts one or more terms of which an index, obtained for each of the terms by analyzing all of the contents, satisfies a predetermined condition among the plurality of terms included in the contents as the feature terms.

20. A non-transitory computer readable medium storing a program causing a computer to realize:
a function of obtaining time-point information corresponding to a plurality of time-points associated with target data;
a function of obtaining feature information corresponding to one or more feature terms from the target data; and
a function of generating search conditions corresponding to the plurality of time-points by combining the time-point information and the feature information.
